(19) United States
(12) Patent Application Publication
(10) Pub. No.: US 2004/0155103 A1
(43) Pub. Date: Aug. 12, 2004

(54) Card processing verification

(75) Inventors: Gary M. Klinefelter, Eden Prairie, MN (US); Matthew K. Dunham, Eagan, MN (US); Robert E. Francis, Richfield, MN (US); Jon J. Ibs, Minneapolis, MN (US)

Correspondence Address: Brian D. Kaul, Westman, Champlin & Kelly, Suite 1600, 900 Second Avenue South, Minneapolis, MN, 55402-3319, US

(73) Assignee: Fargo Electronics, Inc., Eden Prairie, MN

(21) Appl. No.: 10/643,562

(22) Filed: Aug. 19, 2003

Related U.S. Application Data
(60) Provisional application No. 60/404,440, filed on Aug. 19, 2002.

(51) Int. Cl. G06K 5/00

(52) U.S. Cl. 235/380

(57) ABSTRACT

A method of verifying the processing of a card includes a step of processing a card. Next, a check is made to verify whether the card was completely or incompletely processed. Finally, verification results are generated that indicate whether the card was completely or incompletely processed. Another aspect of the present invention is directed to an identification card manufacturing system that is configured to carry out the method described above.

The present application is based on and claims the benefit of U.S. provisional patent application Serial No. 60/404,440, filed Aug. 19, 2002.

### BACKGROUND OF THE INVENTION

Identification cards are commonly used as a vehicle for identifying the bearer of the card (e.g., driver's licenses), for access control, and other purposes. These identification cards are produced using identification card manufacturing systems, such as those produced by Fargo Electronics, Inc. of Eden Prairie, Minn.

Such systems generally include an application and a card processing component, such as a printhead or data writer. The application generates a card processing job that defines an image to be printed to the card using the printhead, and/or card data to be written to the card using the data writer. Unfortunately, errors can occur during the printing of the image on the card, the writing of the data to the card, or during other processing of the card by the system resulting in incompletely processed cards.

A manual inspection of the cards is typically required to determine whether they are completely or incompletely processed. Such a manual inspection can involve visually inspecting the card to determine whether the image was printed properly, or passing the card through a card reader to determine if the data was written properly. Unfortunately, such card inspection can be imperfect and time consuming

Cards that are determined to be incompletely processed are typically discarded. In some instances, the incompletely processed cards can still be put to use for unauthorized purposes. For example, incompletely processed cards that are visually complete may be used to gain access where no scan of the incomplete data written to the card is performed. Thus, such incompletely processed cards can pose a security risk.

Accordingly, there is a need for automated card inspection to determine whether processed cards have been completely or incompletely processed. Additionally, there is a need to prevent the unauthorized use of cards that are incompletely processed.

### SUMMARY OF THE INVENTION

The present invention is directed to a method of providing card processing verification. In the method, a card is processed, next, a check is made to verify whether the card was completely, or incompletely processed. Finally, verification results are generated that indicate whether the card was completely or incompletely processed. Another aspect of the present invention is directed to an identification card manufacturing system that is configured to carry out the method described above.

### BRIEF DESCRIPTION OF THE DRAWINGS

FIG. 1 is a schematic diagram of an identification card manufacturing system in accordance with various embodiments of the invention.

FIG. 2 is a flowchart illustrating a card processing verification method in accordance with embodiments of the invention.

FIG. 3 is a flowchart illustrating a card processing verification method in accordance with an embodiment of the invention.

FIG. 4 is a schematic diagram of a card that includes various forms of data storage.

FIG. 5 is a flowchart illustrating a card processing verification method in accordance with an embodiment of the invention.

FIG. 6 is a schematic diagram of a card illustrating information that can be contained in data storage of the card.

FIGS. 7-9 are schematic diagrams of cards that include voiding marks in accordance with various embodiments of the invention.

### DETAILED DESCRIPTION OF THE PREFERRED EMBODIMENTS

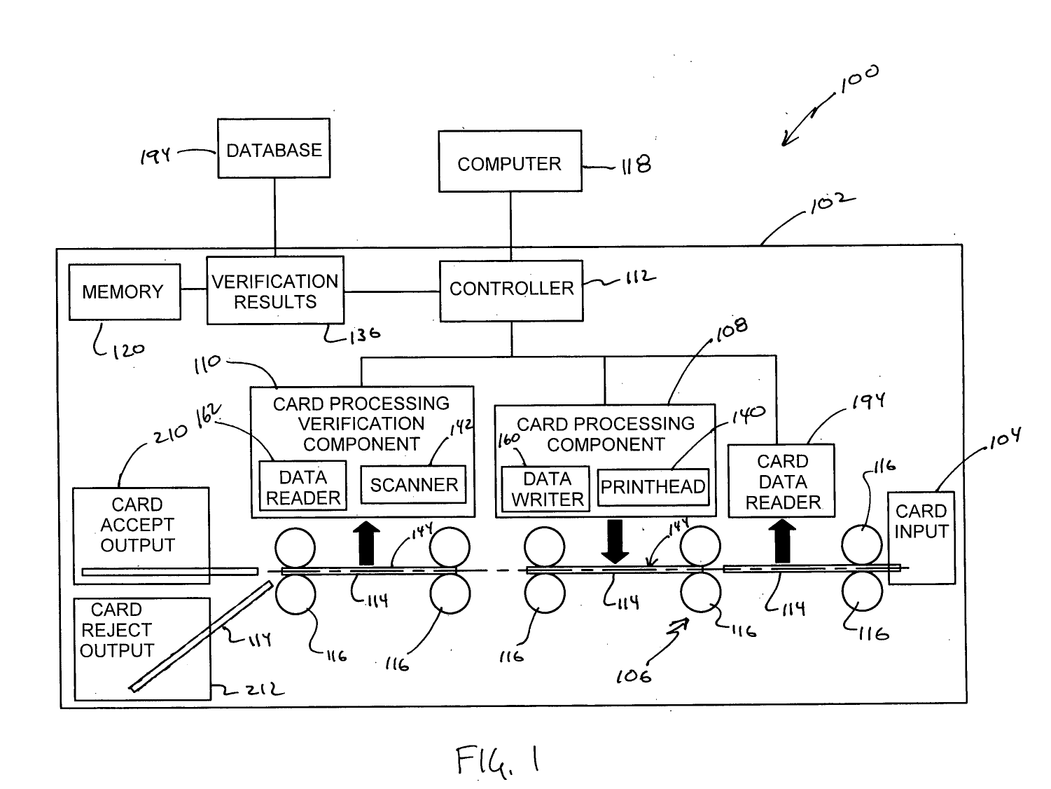

FIG. 1 is a schematic diagram of an identification card manufacturing system 100, in accordance with various embodiments of the invention. System 100 generally includes an identification card manufacturing device 102 that includes a card input 104, a card transport 106, a card processing component 108, a card processing verification component 110, and a controller 112. Card input 104 is configured to provide individual cards 114 to card transport 106 for transport through device 102. Card transport 106 includes various card feeding components 116, such as card feed rollers or other suitable mechanisms.

Controller 112 is configured to control the components of device 102 in accordance with a card processing job. The card processing job is generally produced by an application running on computer 118. Alternatively, the application can reside in memory 120 of device 102 for execution by controller 112. The card processing job includes data containing instructions for the processing of cards 114 using card processing component 108. The card processing verification component 110 is configured to verify that the cards 114 are completely or incompletely processed by comparing data extracted from the processed card 114 to the data of the card processing job, as will be discussed below in greater detail.

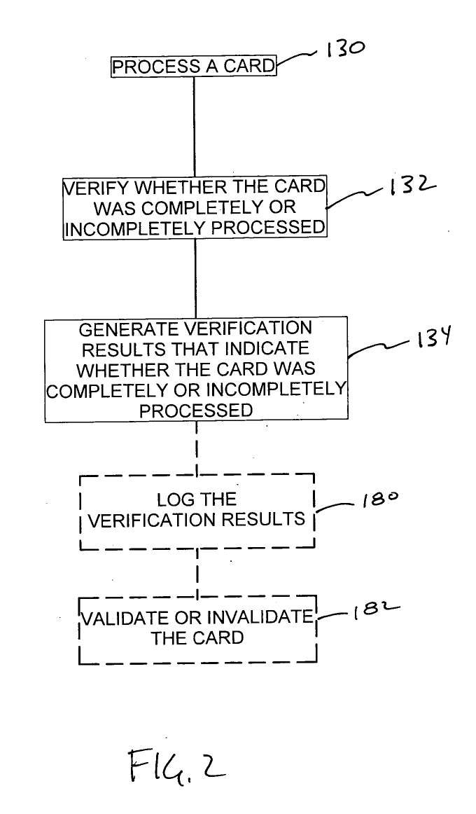

FIG. 2 is a flowchart illustrating a general method of the present invention for providing card processing verification in accordance with various embodiments of the invention, which can be implemented by system 100. At step 130, a card 114 is processed by card processing component 108 in accordance with data of the card processing job. Next, at step 132, the card processing verification component 110 verifies whether the card 114 was completely or incompletely processed by the card processing component 108. This is generally accomplished by comparing data obtained from the processed card 114 to the data of the card processing job. Finally, at step 134, verification results 136 (FIG. 1) are generated, which indicate whether the card was completely or incompletely processed. Verification results 136 can be provided back to the application that generated the card processing job. Additionally, as will be explained below, the verification results 136 can also be used to determine how to handle the card 114 and can be used to maintain an account of the processing of cards 114.

In accordance with one embodiment of the invention, card processing component 108 includes a printhead 140 and card processing verification component 110 includes a scanner 142, as shown in FIG. 1. Printhead 140 can be an ink jet printhead, a thermal printhead, or other suitable print mechanism.

In accordance with this embodiment of the invention, the processing of the card 114 at step 130 is performed by printhead 140, which prints an image on surface 144 in accordance with print image data of the card processing job, as indicated at step 150 of FIG. 3. Next, at step 152, scanner 142 scans the printed image on surface 144 of card 114 and generates scanned image data corresponding to the scanned printed image. At step 154, the scanned image data is compared to the print image data of the card processing job by controller 112 to complete the card processing verification step 132 (FIG. 2) and determine whether card 114 was completely or incompletely processed. In general, card 114 is deemed to be completely processed when the scanned image data substantially matches the print image data and incompletely processed when the scanned image data does not substantially match the print image data. The threshold for determining whether there is a substantial match or substantial mismatch between the scanned image data and the printed image data is preferably empirically set. Finally, at step 156, verification results 136 are generated that indicate whether the card was completely or incompletely processed.

It should be understood that the image printed on surface 144 can be a composite image that includes various image components, such as a primary image and a watermark. The print image data of the card processing job can represent both the primary image and the watermark, the primary image alone, or the watermark alone. Accordingly, the comparison between the scanned image data and the print image data at step 154 can be used to detect whether one of the components of the printed image was printed properly.

In accordance with another embodiment of the invention, card processing component 108 includes a data writer 160 and card processing verification component 110 includes a data reader 162, as shown in FIG. 1. Data writer 160 can be a magnetic stripe writer configured to write data to a magnetic stripe 164, or a chip encoder that is configured to write data to a memory chip 166 embedded in card 114, as shown in FIG. 4. Data reader 162 is configured to read the data written to card 114 by the data writer 160. Data reader 162 can be a magnetic stripe reader that is configured to read data written to magnetic stripe 164 or a chip reader that is configured to read memory 166 of card 114.

In accordance with this embodiment of the invention, the processing of the card 114 at step 130 of the method is performed by data writer 160, which writes data to card 114 in accordance with the card data of the card processing job, as indicated at step 170 of the method of FIG. 5. Next, at step 172, data reader 162 reads the data written to card 114 by data writer 160, which is compared to the card data by controller 112 at step 174 to complete the card processing verification step 132 (FIG. 2) and determine whether card 114 was completely or incompletely processed. In general, card 114 is deemed to be completely processed when the read data substantially matches the card data and incompletely processed when the read data does not substantially match the card data. In accordance with one embodiment of the invention, a substantial match between the read data and the card data exists only when there is an exact match between the read data and the card data. Finally, at step 176, verification results 136 are generated that indicate whether the card was completely or incompletely processed. As mentioned above, the verification results 136 can be generated by controller 112 as indicated in FIG. 1.

In accordance with one embodiment of the invention, when it is determined that the card was incompletely processed in step 174, steps 170, 172 and 174 can be repeated a predetermined number of time to ensure that the card is incapable of being completely processed. As a result, it is less likely that cards that are capable of being completely processed will be prematurely labeled as defective.

Referring again to FIG. 2, the general card processing verification method of the present invention can also include a step 180, in which the verification results are logged, and a step 182, in which the card is validated or invalidated. The logging step 180 generally involves recording information including the verification results 136 for cards that are completely or incompletely processed. In accordance with one embodiment of the invention, the verification results 136 include a serial number that uniquely identifies a card 114 that was completely or incompletely processed. In accordance with this embodiment, each card 114 includes the serial number 190 in data storage 192, as shown in FIG. 6. Data storage 192 can be a magnetic stripe 164 or a memory chip 166, as shown in FIG. 4. The serial number 190 of card 114 can be read by card data reader 194, and provided to controller 112. Alternatively, data reader 162 can be used to obtain the serial number 190 of card 114. In this manner, each card 114 can be accounted for as to whether it was completely or incompletely processed by system 100. The log of the verification results is preferably contained in memory 120 of device 102, computer 118, or a remotely located data base 194, as shown in FIG. 1.

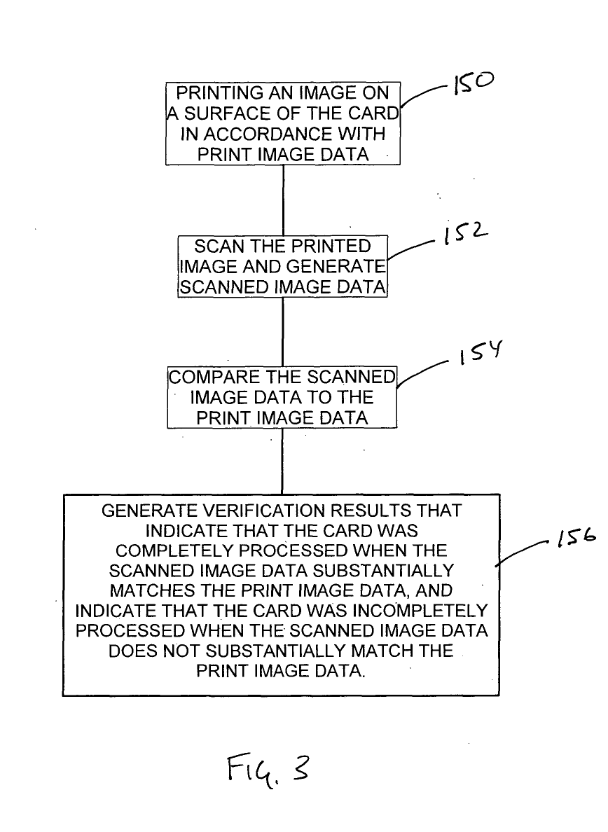

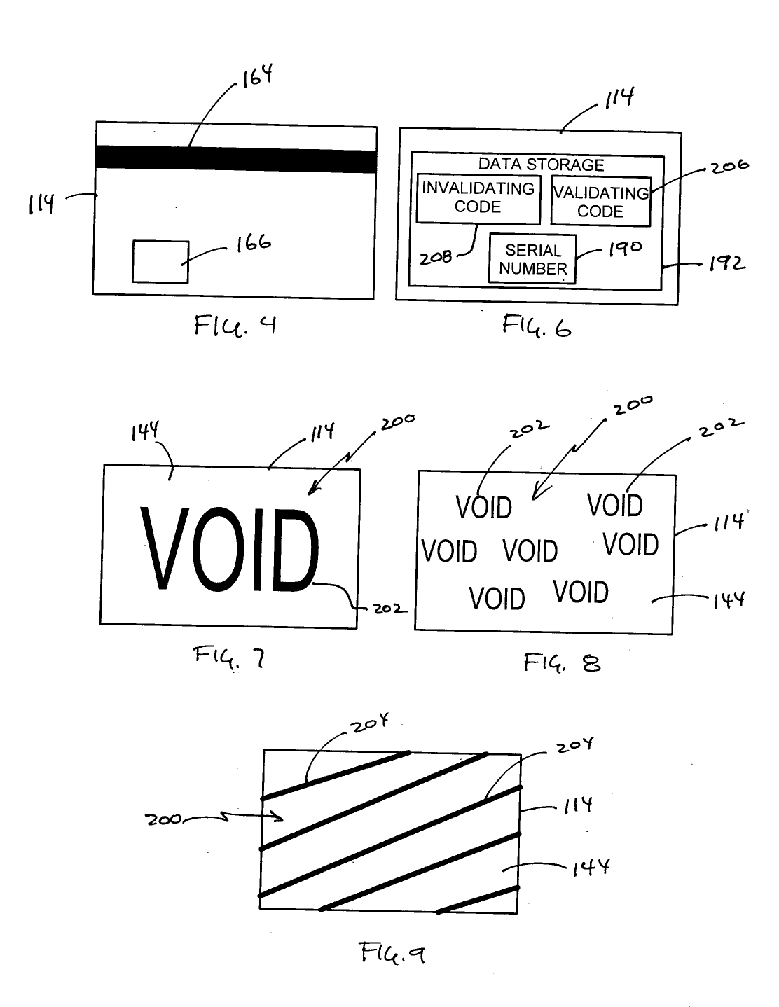

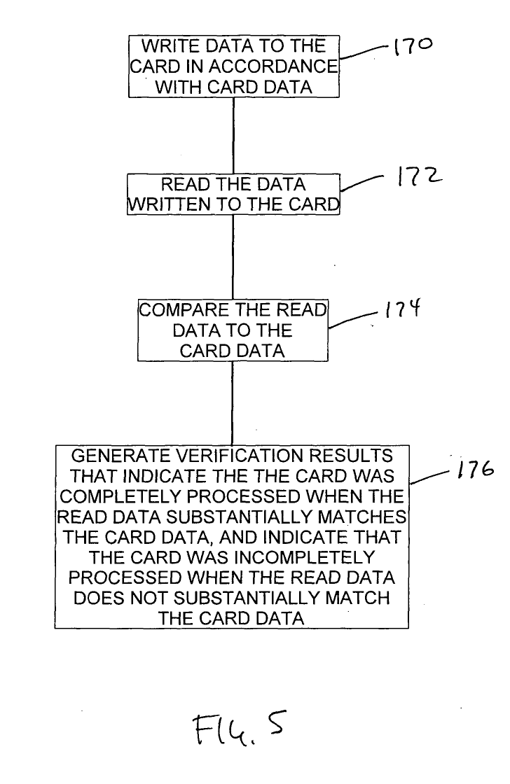

There are many ways in which a completely processed card 114 can be validated, or an incompletely processed card 114 can be invalidated. In accordance with one embodiment of the invention, incompletely processed cards are invalidated by printing a voiding mark 200 on surface 144 of an incompletely processed card 114. Voiding mark 200 is preferably applied to cards 114 that were deemed to be incompletely processed in accordance with the method of FIG. 3. In particular, when card 114 is determined to be incompletely processed due to a comparison between the scanned data of an image printed to surface 144 by printhead 140 and the print image data, voiding mark 200 is preferably printed over the printed image on surface 144 of card 114. The voiding mark can comprise one or more words 202, such as “VOID”, as shown in FIGS. 7 and 8. Alternatively, voiding mark 200 can comprise a plurality of lines 204, as shown in FIG. 9, or can completely print over the surface 144 of card 114.

In accordance with another embodiment of the invention, the validating or invalidating step 182 includes writing a validating code 206 or an invalidating code 208 to data storage 192 of card 114 when the card 114 is determined to be completely, or incompletely processed, respectively. Accordingly, when the verification results indicate that the card was completely processed, validating code 206 can be written to data storage 192 of card 114. Similarly, when the verification results indicate that the card was incompletely processed, invalidating code 208 can be written to data storage 192 of card 114. The validating and invalidating codes 206 and 208 can be checked when the card 114 is used, for example, to gain access to a secure location. When the card contains the invalidating code 208, it can be assumed that the user of the incompletely processed card 114 is unauthorized for access to the location and access can be denied.

In accordance with one embodiment of the invention, identification card manufacturing device 102 can include a card accept output 210 and a card reject output 212. Cards 114 that are completely processed are discharged through the card accept output 210 for collection by a card hopper. Cards 114 that are incompletely processed are discharged through the card reject output 212. In this manner, completely processed cards 114 can be separated from those that are incompletely processed.

Although the present invention has been described with reference to preferred embodiments, workers skilled in the art will recognize that changes may be made in form and detail without departing from the spirit and scope of the invention. For example, card processing component 108 and card processing verification component 110 can be combined in a single component, such as a magnetic stripe writer and reader, rather than separate components.

What is claimed is:

1. A method of manufacturing a card comprising:
a) processing a card;
b) verifying whether the card was completely or incompletely processed; and
c) generating verification results indicating whether the card was completely or incompletely processed.

2. The method of claim 1, wherein:
the processing step a) includes printing an image on a surface of the card in accordance with print image data;
the verifying step b) includes scanning the printed image and generating scanned image data corresponding to the printed image, and comparing the scanned image data to the print image data; and
the verification results indicate that the card was completely processed when the scanned image data substantially matches the print image data, and indicate that the card was incompletely processed when the scanned image data does not substantially match the print image data.

3. The method of claim 2 including d) invalidating the card when it is determined in the verifying step b) that the card was incompletely processed.

4. The method of claim 3, wherein the invalidating step d) includes printing a voiding mark on the card over the image printed on the card in the processing step a).

5. The method of claim 1, wherein:
the processing step a) includes writing data to the card in accordance with card data;
the verifying step b) includes reading the data written to the card in the processing step a), and comparing the read data to the card data; and
the verification results indicate that the card was completely processed when the read data substantially matches the card data, and indicate that the card was incompletely processed when the read data does not substantially match the card data.

6. The method of claim 5 including d) invalidating the card when it is determined in the verifying step b) that the card was incompletely processed.

7. The method of claim 6, wherein the invalidating step d) includes writing a voiding code to the card, the voiding code being indicative of an invalid card.

8. The method of claim 1, wherein:
the processing step a) includes writing data on a magnetic stripe of the card in accordance with card data;
the verifying step b) includes reading the data written to the magnetic stripe in the processing step a), and comparing the read data to the card data; and
the verification results indicate that the card was completely processed when the read data substantially matches the card data, and indicate that the card was incompletely processed when the read data does not substantially match the card data.

9. The method of claim 8 including d) invalidating the card when it is determined in the verifying step b) that the card was incompletely processed.

10. The method of claim 9, wherein the invalidating step d) includes writing a voiding code to the magnetic stripe, the voiding code being indicative of an invalid card.

11. The method of claim 1, wherein:
the processing step a) includes writing data to a memory chip of the card in accordance with card data;
the verifying step b) includes reading the data written to the memory chip in the processing step a), and comparing the read data to the card data; and
the verification results indicate that the card was completely processed when the read data substantially matches the card data, and indicate that the card was incompletely processed when the read data does not substantially match the card data.

12. The method of claim 11 including d) invalidating the card when it is determined in the verifying step b) that the card was incompletely processed.

13. The method of claim 12, wherein the invalidating step d) includes writing a voiding code to the memory chip of the card, the voiding code being indicative of an invalid card.

14. The method of claim 1 including d) logging the verification data for the card when it is determined in the verifying step b) that the card was completely processed.

15. The method of claim 14, wherein the verification data includes a serial number that uniquely identifies the card.

16. The method of claim 15 including reading the serial number from the card.

17. The method of claim 1 including d) logging the verification data for the card when it is determined in the verifying step b) that the card was incompletely processed.

18. The method of claim 17, wherein the verification data includes a serial number that uniquely identifies the card.

19. The method of claim 18 including reading the serial number from the card.

20. The method of claim 1 including d) invalidating the card when it is determined in the verifying step b) that it was incompletely processed.

21. The method of claim 20, wherein the voiding step includes printing a voiding mark on the card using a printhead.

22. The method of claim 21, wherein the voiding mark includes a plurality of lines.

23. The method of claim 21, wherein the voiding mark substantially covers a surface of the card.

24. The method of claim 21, wherein the voiding mark includes a word.

25. The method of claim 20, wherein the invalidating step includes writing a voiding code to the card, the voiding code being indicative of an invalid card.

26. The method of claim 25, wherein the voiding code is written on a magnetic stripe of the card.

27. The method of claim 25, wherein the voiding code is written to a memory chip of the card.

28. The method of claim 1 including d) validating the card when it is determined in the verifying step b) that it was completely processed.

29. The method of claim 28, wherein the validating step d) includes writing a validating code on a magnetic stripe of the card or to a memory chip of the card.

30. The method of claim 1, wherein:
the processing step a) is performed in accordance with a card processing job produced by an application; and
method including d) providing the verification results to the application.

31. A method of manufacturing a card comprising:
a) printing an image on the surface of the card in accordance with print image data;
b) scanning the image printed on the card to thereby generate scanned image data;
c) comparing the scanned image data to the print image data; and
d) generating verification results that indicate either that the card was completely processed when the scanned image data substantially matches the print image data, or that the card was incompletely processed when the scanned image data does not substantially match the print image data.

32. The method of claim 31 including e) invalidating the card when the verification results indicate that the card was incompletely processed.

33. The method of claim 32, wherein the invalidating step e) includes printing a voiding mark on the card over the image printed on the card in the processing step a).

34. The method of claim 32, wherein the invalidating step e) includes writing a voiding code to a magnetic stripe or a memory chip of the card.

35. The method of claim 31 including e) validating the card when the verification results indicate that the card was completely processed.

36. The method of claim 35, wherein the validating step e) includes writing a validating code to a magnetic stripe or a memory chip of the card.

37. The method of claim 35, wherein the validating step e) includes printing a validating mark on the card.

38. A method of manufacturing a card comprising:
a) writing data to the card in accordance with card data;
b) reading the data that was written to the card;
c) comparing the read data to the card data; and
d) generating verification results that indicate that the card was completely processed when the read data substantially matches the card data, and indicate that the card was incompletely processed when the read data does not substantially match the card data.

39. The method of claim 38 including d) invalidating the card when it is determined that the card was incompletely processing.

40. The method of claim 39, wherein the invalidating step d) includes writing a voiding code to the card, the voiding code being indicative of an invalid card.

41. The method of claim 38, wherein the data is written to a magnetic stripe of the card in the writing step a).

42. The method of claim 41, wherein the data is written to a memory chip of the card in the writing step a).

43. An identification card manufacturing system comprising:
a card input;
a card transport configured to receive individual cards at the card input and transport the cards along a card processing path;
a card processing component configured to process cards delivered by the card transport;
a card processing verification component configured to verify that the cards are either completely or incompletely processed; and
a controller configured to generate verification results that are indicative of whether the card was completely or incompletely processed.

44. The system of claim 43, wherein:
the card processing component is a printhead configured to print an image on a surface of a card delivered by the card transport in accordance with print image data;
the card processing verification component includes a scanner configured to scan the image printed on the card and generate scanned image data in response thereto; and
the controller is configured to compare the scanned image data to the print image data and generate the verification results, which indicate that the card was completely processed when the scanned image data substantially matches the print image data, and indicate that the card was incompletely processed when the scanned image data does not substantially match the print image data.

45. The system of claim 43, wherein:
the card processing component is a data writer configured to write data on the card in accordance with card data;
the card processing verification component includes a data reader configured to read the data written to the card; and
wherein the controller is configured to compare the read data to the card data and generate the verification results, which indicate that the card was completely processed when the read data substantially matches the card data, and indicate that the card was incompletely reprocessed when the read data does not substantially match the card data.

46. The system of claim 45, wherein the card includes a memory chip, the data writer includes a chip encoder, and the data reader of the card processing verification component includes a chip reader.

47. The system of claim 45, wherein the card includes a magnetic stripe, the data writer includes a magnetic stripe writer, and the data reader of the card processing verification component includes a magnetic stripe reader.

48. The system of claim 43 including a card accept output through which cards that are completely processed are discharged.

49. The system of claim 43 including a card reject output through which cards that are incompletely processed are discharged.

50. An identification card manufacturing system comprising:
a card input;
a card transport configured to receive individual cards at the card input and transport the cards along a card processing path;
a printhead configured to print an image on a surface of a card delivered by the card transport in accordance with print image data;
a scanner in line with the card processing path and configured to scan the image on the surface of the card and generate scanned image data in response thereto; and
a controller configured to compare the scanned image data to the print image data and generate verification results that indicate either that the card was completely processed when the scanned image data substantially matches the print image data, or that the card was incompletely processed when the scanned image data does not substantially match the print image data.

51. The system of claim 50, wherein the controller is configured to void cards that are incompletely processed.

52. The system of claim 50 including a database containing a log of the verification results.

53. The system of claim 50 including a card data reader configured to read a serial number that uniquely identifies the card, wherein the verification results include the serial number for each card.
